(19) United States
(12) Patent Application Publication
(10) Pub. No.: US 2026/0189517 A1
(43) Pub. Date: Jul. 2, 2026

(54) METHOD FOR TRANSMITTING ETHERNET MAC FRAME

(71) Applicant: Mitsubishi Electric Corporation, Tokyo (JP)

(72) Inventor: Christophe MANGIN, Rennes Cedex 7 (FR)

(73) Assignee: Mitsubishi Electric Corporation, Tokyo (JP)

(21) Appl. No.: 19/130,730

(22) PCT Filed: Aug. 7, 2023
(86) PCT No.: PCT/JP2023/029480

§ 371 Date: May 16, 2025

(30) Foreign Application Priority Data
Dec. 19, 2022 (EP) 22306945.1

(51) Int. Cl. H04L 49/25

(52) U.S. Cl. CPC H04L 49/251

(57) ABSTRACT

The present disclosure relates to a method for transmitting an Ethernet MAC frame, implemented by a communication device having an egress port to form the frame to be transmitted based on received data of said frame. The method comprises:—Checking whether, among said data of the frame, at least one parameter (chunk, transmitChunkOffset, chunkPresent) related to a segmentation of said frame is present, and in this case,—Start forming the frame at the egress port without waiting for a reception of all the frame data, according to a cut-through forwarding mode.

### TECHNICAL FIELD

The present disclosure relates to telecommunication signals processing.

The IEEE 802 standards, in particular the Ethernet related standards specified by IEEE 802.3 and IEEE 802.1, are based on the layered protocol model introduced by the OSI Basis Reference Model, where protocol entities instantiated in a given protocol layer communicate with other protocol entities instantiated in the same protocol layer. This communication taking place within a given layer relies on the service provided by the protocol layer immediately below.

The relative layer position of protocol entities and services are referred to by the index N. Thus the (N)-service is provided by an (N)-entity that uses the (N−1)-service provided by an (N−1)-entity. The (N)-service user is an (N+1)-entity.

Each service is provided to a single protocol entity at a Service Access Point (SAP). A given (N)-entity can support a number of N-SAPs and use one or more (N−1)-SAPs. A SAP is then an abstraction that marks the boundary between protocol specifications and specifies the observable behaviour between entities.

(N)-Service users interact with (N)-Service providers through primitives and their parameters.

FIG. 1 illustrates these concepts through the Media Access Control (MAC) sublayer (Included in OSI layer 2) of Ethernet networks, which contains MAC entities providing MAC service to MAC service users (MAC clients).

In the case of the IEEE 802 MAC Service, two primitives are defined:
a data request and a data indication that convey as parameters
   a MAC destination address,
   a MAC source address,
   a MAC Service Data Unit (MSDU) containing one or more octets, and
   priority parameters.

These parameters constitute a frame.

FIG. 1 illustrates the MAC service primitives possibly used in a bridge (as specified in IEEE Std 802.1AC): MA_UNITDATA.request and MA_UNITDATA.indication.

Specification IEEE Std 802.3 specifies the service provided by the MAC sublayer to the client of the MAC with slightly modified primitive's names and parameters.

FIG. 2 illustrates the primitives handled by the MAC service (supported by the MAC sublayer as specified in IEEE Std 802.3) with the MAC client (upper layer) and the Physical layer (PHY, lower layer).

The parameters of the primitives are described below:

MA_DATA.request {

destination_address,
source_address,
mac_service_data_unit,
frame-check-sequence
}.

The destination_address parameter specifies either an individual or a group MAC entity address. It contains sufficient information to create the DA field (Destination Address) that is prepended to the frame by the local MAC sublayer entity and any physical information.

The source_address parameter, if present, specifies an individual MAC address. If the source_address (SA) parameter is omitted, the local MAC sublayer entity inserts a value associated with that entity.

The mac_service_data_unit parameter specifies the MAC service data unit to be transmitted by the MAC sublayer entity. There is sufficient information associated with the mac_service_data_unit for the MAC sublayer entity to determine the length of the data unit.

The frame_check_sequence parameter, if present, specifies the frame check sequence field for the frame. If the frame_check_sequence parameter is omitted, the local MAC sublayer entity computes this field and appends it to the end of the frame.

When received, the MAC sublayer entity inserts all MAC specific fields (DA, SA, . . . ) and pass the frame formed from this information to the lower protocol layers for transfer to the peer MAC sublayer entities.

MA_DATA.indication {

destination_address,
source_address,
mac_service_data_unit,
frame-check-sequence,
reception_status
}

The destination_address parameter may be either an individual or a group address as specified by the DA field of the incoming frame.

The source_address parameter is an individual address as specified by the SA field of the incoming frame.

The mac_service_data_unit parameter specifies the MAC service data unit as received by the local MAC entity.

The frame_check_sequence parameter is the cyclic redundancy check value as specified by the FCS field (for “Frame Check Sequence”) of the incoming frame. This parameter may be either omitted or (optionally) passed by the MAC sublayer entity to the MAC client.

The reception_status parameter is used to pass status information to the MAC client entity.

The MA_DATA.indication is passed from the MAC sublayer entity to the MAC client entity or entities to indicate the arrival of a frame to the local MAC sublayer entity that is destined for the MAC client. Such frames are reported only if they are validly formed, received without error.

The IEEE 802.3's MA_DATA.x primitives are mapped/adapted to the respective IEEE 802.1's MA_UNITDATA.x primitives by:
ignoring the priority parameter specified for M_UNITDATA.request to form the corresponding MA_DATA.request
not providing the priority parameter specified for M_UNITDATA.indication from the corresponding MA_DATA.indication
removing the frame_check sequence parameter to form the corresponding MA_UNITDATA.indication
not mapping the reception_status in the corresponding MA_UNITDATA.indication.

As to IEEE standard 802.1 bridges, according to a VLAN bridge architecture, such a bridge comprises at least one bridge component, which includes:
A MAC Relay Entity that interconnects the Bridge's Ports
At least two Ports
Higher layer entities.

The architecture of a VLAN bridge is illustrated in FIG. 3.

The MAC Relay Entity handles the media access method-independent functions of relaying frames among Bridge Ports, filtering frames, and learning filtering information. It uses the Enhanced Internal Sublayer Service (EISS) provided by each Bridge Port. The EISS augments the ISS (Internal Sublayer Service) that provides the basic MAC service in a bridge port.

In bridge ports, the MAC client is formed of the ISS and the EISS, with the ISS performing a convergence function as a client of the IEEE 802.3 MAC sublayer by translating the primitive exchanged with the IEEE 802.3 MAC sublayer.

In this particular case, the primitives provided by the ISS are the M_UNITDATA.indication and the M_UNITDATA.request, which convey the following parameters:

M_UNITDATA.indication {

destination_address,
source_address,
mac_service_data_unit,
priority,
drop_eligible,
frame-check-sequence,
service_access_point_identifier,
connection_identifier
}

M_UNITDATA.request {

destination_address,
source_address,
mac_service_data_unit,
priority,
drop_eligible,
frame-check-sequence,
service_access_point_identifier,
connection_identifier
}.

The M_UNITDATA.request is translated into an IEEE 802.3 MA_DATA.request as follows:
The destination_address and source_address parameters are passed unaltered.
The mac_service_data_unit is potentially padded to comply with the minimum frame length required by IEEE 802.3.
If a frame_check_sequence is included in the M_UNITDATA.request primitive, its value is adjusted to include any added padding.
The priority, drop eligible, service_access_point_identifier, and connection_identifier parameters are ignored.

Conversely, the IEEE 802.3 MA_DATA.indication is translated into an M_UNITDATA.request as follows:
The destination_address, source_address, mac_service_data_unit, and frame_check_sequence parameters are passed unaltered.
The drop_eligible parameter of the M_UNITDATA.indication is FALSE.
The priority parameter of the M_UNITDATA.indication takes the value of the Default Priority parameter for the SAP on which the MA_DATA.indication was received. The priority parameter can be set by management or left to its default value of 0.

The EISS' primitives add three parameters to the ISS primitives, among which the vlan_identifier that carries the VID included in the VLAN-Tag of a VLAN-tagged frame. The mac-service-data-unit parameter passed over the EISS is two-byte shorter than the mac-service-data-unit parameter passed over the ISS, since the vlan_id parameter is extracted from the two-byte VLAN-Tag located in the two first bytes of the ISS' mac-service-data-unit parameter.

The main functions of a VLAN bridge are:
Relay and filter frames
Maintain the information required to make frame filtering and relaying decisions
Management.

They are distributed between the bridge's port, forwarding process and higher-layer functions and can be listed as follows:
Frame reception
Discard of received frame in error
Discard of frames that do not carry user data
Priority and drop eligibility decoding from a VLAN tag, if present, and regeneration of priority, if required
Assignment of a VID to each received frame
Ensure that each frame is confined to an active topology
Frame discard to support management control over the active topology of each VLAN
Frame discard following the application of filtering information
Metering of frames, potentially marking as drop eligible or discarding frames exceeding bandwidth limits
Forwarding of received frames to other Bridge Ports
Selection of traffic class and queuing of frames by traffic class
Frame discard to ensure that a maximum Bridge transit delay is not exceeded
Preferential discard of drop eligible frames to preserve QoS for other frames
Selection of queued frames for transmission
Mapping of SDUs and FCS recalculation, if required
Frame discard on transmittable SDU size exceeded
Selection of outbound access priority
Frame transmission.

The set of functions performing the actions taken for a given frame received on a given Port (termed “the reception Port”) by the MAC Relay Entity constitutes the Forwarding Process. A frame can be forwarded for transmission on some Ports (termed “transmission Ports”) and discarded without being transmitted at other Ports.

The Forwarding Process' functions are illustrated in FIG. 4.

The MAC sublayer operation described here is limited to the full duplex operation as specified in IEEE Std 802.3 Annex 4A.

For the transmission, upon a MAC client request, the data supplied by the client is used by the Transmit Data Encapsulation component of the full duplex MAC sublayer to construct the frame.

It prepends a preamble and a Start of Frame Delimiter at the head of the frame and possibly appends a Pad at the end of the MAC service data unit to meet the minimum frame size requirement. It also prepends the destination and source addresses and optionally appends the frame check sequence for error detection. Frame transmission is initiated once the carrierSense signal is removed and after the required inter-frame delay (see FIG. 1).

The MAC sublayer indicates to the MAC client when the transmission has completed and waits for the next frame transmission request.

The IEEE Std 802.3 specifies the control flow of the transmission operation as presented in FIG. 5.

As for the reception, the reception of a frame is detected by the Physical Layer by synchronizing on an incoming preamble and indicating the receiveDataValid signal (in the MAC sublayer). The Physical Layer passes further decoded bits to the MAC sublayer that discards the preamble and Start of Frame Delimiter. Received bits are collected as long as the receiveDataValid signal remains active. Upon its removal the frame is truncated to an octet boundary and passed to the Receive Data Decapsulation for processing.

The Receive Data Decapsulation passes the Destination Address (DA), the Source Address (SA), the MAC service data unit, and (optionally) the Frame Check Sequence (FCS) as well as a status code.

It checks the FCS to detect errored frames.

The IEEE Std 802.3 also illustrates the control flow of the reception operation, as presented in FIG. 6.

The overview of the full duplex MAC sublayer given above shows that the information entity handled by the IEEE Std 802.3 MAC sublayer is a whole frame.

In reception, the MAC sublayers wait for the indication of the completion of the bit-by-bit reception of a frame by the Physical Layer, through the receiveDataValid envelop signal, before starting the frame decapsulation process and presenting the received frame to the MAC client via the indication primitive.

Similarly, in transmission, the MAC client must provide all the information elements required by the MAC to the IEEE 802.3 MAC sublayer so that the latter can proceed with the assembly of the frame and provide it to the Physical Layer for bit-by-bit transmission.

Hence, the MAC client involved in the ports of IEEE 802.1 compliant bridges (ISS and above) also handles whole frames, that are the information units manipulated by the forwarding process function of MAC Relay entity in the bridges.

This way of transmitting, receiving and forwarding a frame, called “store and forward”, implies a latency proportional to the size of the frame each time a network node including a MAC sublayer and a MAC relay entity is traversed.

This accumulative latency is adversary to the transmission performance required by some time-critical applications such as industrial, audio/video or internal data center communications.

A reduction of this latency to a minimum can be achieved by modifying the behavior of the IEEE 802.3 MAC sublayer so that it handles the frames in smaller consecutive parts that carry enough information in order to be processed by the bridge's MAC relay entity. Such a forwarding principle is called “cut-through forwarding” and can lead to the frames being forwarded on the egress port of a bridge before it is totally received over the ingress port.

Since cut-through forwarding is not specified by IEEE 802.3 and 802.1 standards, no method for identifying frames to be cut-through forwarded is defined.

By handling the frame segments before the FCS, computed over the whole frame, has been checked, forwarding in cut-through mode can introduce the risk that:
the identification of the frames to be cut-through forwarded
and the forwarding process
   take errored frame information as input for their decisions.

This information includes the DA, SA and some other data field included in MAC service data unit (e.g. the VLAN-ID in the VLAN-Tag). Neither the IEEE 802.3 MAC sublayer nor the IEEE 802.1 MAC clients and forwarding process provide protection against such errors.

The present disclosure aims to improve the situation.

To that end, it proposes a method for transmitting an Ethernet MAC frame, implemented by a communication device having an egress port to form the frame to be transmitted based on received data of said frame, the method comprising:
Checking whether, among said data of the frame, at least one parameter related to a segmentation of said frame is present, and in this case,
Start forming the frame at the egress port without waiting for a reception of all the frame data, according to a cut-through forwarding mode.

The aforesaid “at least one parameter” can be typically one of those presented for example in the transmission scheme of FIG. 19 (right lower frame), such as “chunk”, “transmitChunkOffset”, “chunkPresent”, as presented in the examples of embodiment detailed below.

The aforesaid cut-through forwarding mode makes it possible therefore to start sending first bits of a frame even if the whole frame itself (i.e. its last bits) is not ready yet for transmission. This cut-through forwarding mode opposes then to the usual store and forward mode usually used for transmitting a MAC Ethernet frame where its last bits need to be processed before starting the frame transmission.

Typically, in an embodiment where the communication device comprises an ingress port to receive data of the frame to transmit, the step of forming the frame can be started at the egress port without waiting for a reception of all the frame data at the ingress port.

Therefore, when forwarding a frame from one communication device to another, the frame transmission can start even before receiving its last bits.

In an embodiment where the communication device comprises a bridge (comprising the aforesaid egress port and/or ingress port, and) operating according to an OSI layers' model comprising:
a MAC sublayer for providing a MAC service,
an upper layer related to a MAC client,
and a lower physical layer,
   When said parameter related to frame segmentation is present, said MAC client provides a series of frame segments called “chunks” to the MAC sublayer to implement a frame transmit function (TransmitFrame as presented in the examples below), uninterruptedly as long as the frame to be transmitted is not completely transferred over the MAC service layer.

In an embodiment, the frame data further include a chunk size parameter and chunks are progressively passed up to the MAC client each time a number of bits of the frame equal to the chunk size parameter is received from said physical layer.

In an embodiment, the frame data further include a chunk offset parameter indicating a position of a chunk in a succession of bits constituting the frame, relatively to a beginning of the frame.

In an embodiment, a specific primitive is invoked by said MAC client (called “MA_DATA_CHUNK.request” in the examples below) for requesting a transmission service to said MAC sublayer and defines parameters related to:
A chunk, aiming at a segment of frame to be transmitted, and
A chunk offset, aiming at an offset of said chunk relative to a beginning of the frame.

This offset parameter (called “transmitChunkOffset” in the figures and in the examples of embodiment below) makes it possible to identify in particular the “0-offset” chunk corresponding to a beginning of a frame, and thereby to identify a new frame to transmit in the cut-through forwarding mode.

In an embodiment, the frame transmit function (called “TransmitFrame” in the examples below) calls a procedure (named “TransmitDataEncap” in the examples) for encapsulating frame data to transmit. This procedure includes a checking as to whether a chunk is to be processed instead of a whole frame, depending on whether said parameter (“chunkPresent”) is present or not, respectively.

In this embodiment, this procedure, when said parameter is present, can prepend a preamble and a start frame delimiter at a head of a first chunk of the frame.

The usefulness of labelling the chunks' offsets and more particularly the “0” offset of the first chunk appears therefore from this embodiment.

In this embodiment then, the first chunk can be identified by a “0” chunk offset, indicating thereby a start of a new frame.

In reception, when receiving from another communication device a frame formed according to said cut-through forwarding mode, the MAC sublayer can launch a bit receiving procedure (called “BitReceiver” below) comprising a delineation of successive chunks which are passed to the MAC client, from a train of bits received from said physical layer.

Typically, as long as a last chunk of said frame received in said cut-through forwarding mode is not received by the MAC sublayer, a specific primitive (called “MA_DATA_CHUNK.indication” below) can indicate the successive chunks passed to the MAC client.

Otherwise, when the last chunk is received by said MAC sublayer, a general primitive (called “MA_DATA.indication” below) is launched to indicate an end of reception of the whole frame.

Typically, this “general” primitive is the usual one which is called to process the whole frame reception in the usual “store and forward” mode.

Indeed, for the frames' ends in particular, even in the cut-through mode, there is no need of having a primitive other than the one used in the store and forward mode, so that upper OSI layers which could ignore otherwise primitives of the cut-through mode can operate as usual for the processing of an entire frame to process in both modes.

In an embodiment where a first chunk of the received frame is identified by a “0” chunk offset, indicating thereby a start of the received frame, the aforesaid specific primitive (called below “MA_DATA_CHUNK.indication”) declares furthermore at least a destination address of the frame. More particularly, a minimum size of a chunk is set as at least equal to a field bitlength of said destination address, and the MAC sublayer launches a procedure (called below “receiveChunkDecap”) to decapsulate chunks of the received frame, so as to delineate at least the frame destination address from the first chunk (having the “0” offset).

The destination address is typically one of the information which can be exploited by the MAC client for example to know whether the frame is intended indeed to the communication device or whether the frame is to forward to another communication device (and should instantly be transmitted chunk by chunk through the egress port in cut-through mode). More generally, data of a first chunk having a sufficient size to include the Ethernet addresses (destination, source typically) and possibly other first data of a frame (for example tags such as the VLAN tag, or a cut-through mode tag as presented below) can be useful to inform the MAC client (or even upper layers) so as to start the frame processing like in the usual store and forward mode.

In an embodiment, a tag is added to the frame data before the frame transmission, said tag:
indicating that the frame was formed according to the cut-through forwarding mode, and
comprising at least one data for a frame checking at a frame reception, and wherein said communication device, at a reception of a frame from another communication device according to the cut-through forwarding mode:
determines whether said tag is present in the frame, and
in that case, reads said data in the tag to check whether the frame is erroneous or not.

In an embodiment, the aforesaid parameter related to said frame segmentation is declared among other parameters including at least a destination and/or source addresses, and said communication device, in said cut-through forwarding mode, ignores said addresses to start directly forming the frame at the egress port.

Moreover, when a communication device is not configured to implement said cut-through forwarding mode, it can ignore then the parameter related to the frame segmentation and start processing the frame data by taking into account said other parameters including at least the addresses.

Therefore, any device can still operate in the cut-through mode (if it is configured for) or in the store and forward mode, without disturbing the communication abilities of the devices.

The present disclosure aims also at a computer program comprising instructions causing the implementation of the method presented above, when such instructions are run by a processor.

It aims also at a communication device, comprising a processing circuit to implement the method defined above.

More details are presented in the specification below, with reference to the appended drawings.

### BRIEF DESCRIPTION OF DRAWINGS

FIG. 1 illustrates MAC service primitives which can be used in a bridge of a communication device according to prior art disclosed in IEEE Std 802.1AC.

FIG. 2 illustrates primitives according to prior art handled by the MAC service (supported by the MAC sublayer as specified in IEEE Std 802.3) with the MAC client (upper layer) and the Physical layer (PHY, lower layer).

FIG. 3 illustrates a usual architecture of a VLAN bridge.

FIG. 4 illustrates a usual forwarding process function in a bridge relay entity.

FIG. 5 illustrates the control flow of a transmission operation as specified in prior art IEEE Std 802.3.

FIG. 6 illustrates the control flow of a reception operation as specified in prior art IEEE Std 802.3.

FIG. 7 illustrates the usual TransmitFrame operation according to prior art IEEE Std 802.3.

FIG. 8 illustrates the TransmitDataEncap procedure called when the TransmitFrame operation of FIG. 7 is launched.

FIG. 9 illustrates the TransmitLinkMgmt procedure called when the TransmitFrame operation of FIG. 7 is launched.

FIG. 10 illustrates the BitTransmitter process involved when the TransmitFrame operation of FIG. 7 is launched.

FIG. 11 illustrates the usual ReceiveFrame operation according to prior art IEEE Std 802.3.

FIG. 12 illustrates the ReceiveLinkMgmt procedure called when the ReceiveFrame operation of FIG. 11 is launched.

FIG. 13 illustrates the BitReceiver process involved when the ReceiveFrame operation of FIG. 11 is launched.

FIG. 14 illustrates the ReceiveDataEncap procedure called when the ReceiveFrame operation of FIG. 11 is launched.

FIG. 15 shows the MAC client transmit interface operation, where the mac_service_data_unit parameter passed through the MAC client MA_DATA.request primitive is the concatenation of the lengthOrType field and the data field passed to the MAC sublayer, according to the prior art.

FIG. 16 shows the MAC client receive interface operation, where the lengthOrType field and the data payload field parsed from the received MAC frame are concatenated to form the mac_service_data_unit parameter passed with the MA_DATA.indication primitive, according to the prior art.

FIG. 17 shows new parameters chunkParam, transmitChunkOffsetParam, chunkParamPresent included in a frame to indicate the cut-through forwarding mode, here in a TransmitFrame operation, according to the present disclosure.

FIG. 18 shows the TransmitDataEncap procedure modified in the present disclosure to check if a chunk is to be processed instead of a whole frame.

FIG. 19 shows an example of state machine specifying the operation of the MAC service interface that supports both cut-through forwarding mode and the usual store-and-forward mode.

FIG. 20 shows the BitReceiver procedure modified in the present disclosure to delineate the chunks from the train of bits received from the physical layer.

FIG. 21 shows the ReceiveChunk and the ReceiveChunkDecap procedures, implemented in the reception of an incoming frame in the cut-through forwarding mode according to the present disclosure.

FIG. 22 shows parameters used in reception, either in the cut-through mode or in the store and forward mode, depending on whether the ReceiveChunk procedure is activated or not.

FIG. 23 shows the format of a tag included in a frame and indicating whether the frame was encoded according to the cut-through forwarding mode, according to an example of embodiment of the present disclosure.

FIG. 24 shows details of the tag of FIG. 23, in an example of embodiment.

FIG. 25 illustrates schematically a communication device according to the present disclosure, in an example of embodiment.

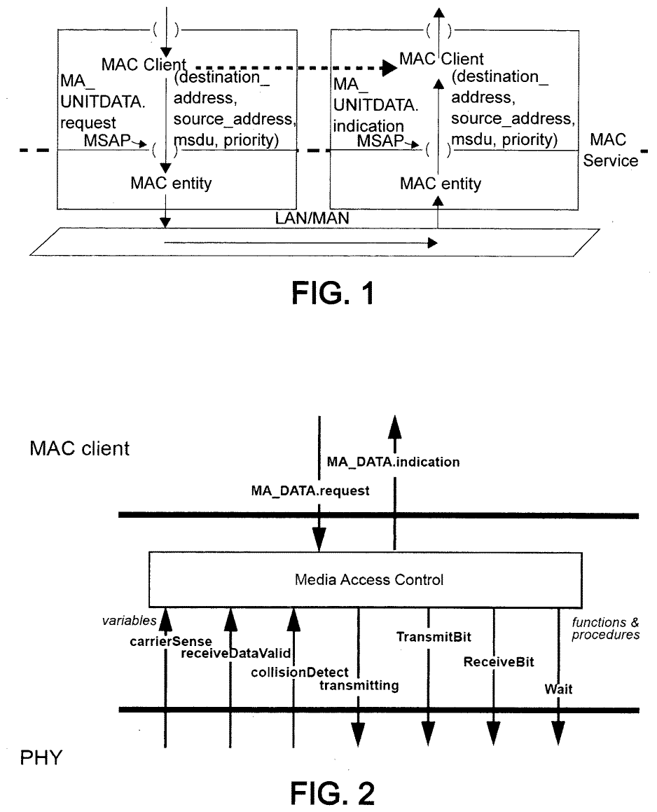

### DESCRIPTION OF EMBODIMENTS

The following disclosure proposes to introduce modifications in the behavior of the IEEE 802.3 MAC sublayer framing (TransmitFrame and ReceiveFrame processes) and medium management functions (BitReceiver and BitTransmitter processes). In transmission, the changes allow to start transmitting a frame as soon as a first segment is made available by the MAC client. In reception, the changes allow to start passing up the successive segments of a frame to the MAC client as soon as the first of these segments is extracted from the Physical Layer.

The standard primitives available at the Service Access Point between the MAC client and the MAC sublayer are enriched with additional primitives signaling the exchange of frame segments over this SAP. Such a set of primitives guarantees the backward compatibility for MAC clients that do not support the new SAP by simply ignoring the additional primitives.
To eliminate the risk of the MAC clients and MAC relay entities performing processing based on errored or incomplete frame information carried in the DA, SA, and MAC service data unit, a Tag is introduced, the CTF-Tag (for “Cut-Through Frame”), that includes complementary frame information and a check sequence protecting the information necessary for the MAC clients and MAC relay entities for their processing.

The following disclosure gives, in a first step, a detailed description of the frame transmission, frame reception, and primitive generation processes, as they are specified in IEEE Std 802.3 Annex 4A. Some simplifications are made, and described, for the sake of alignment with the changes later introduced to support cut-through mode.

The modified transmission, reception, primitives' generation processes as well as the CTF-Tag-based protection are then introduced later in the disclosure.

For the transmission of the IEEE 802.3 MAC Sublayer Frame, the TransmitFrame operation is synchronous of the actual frame transmission: it lasts for the entire frame transmission duration.

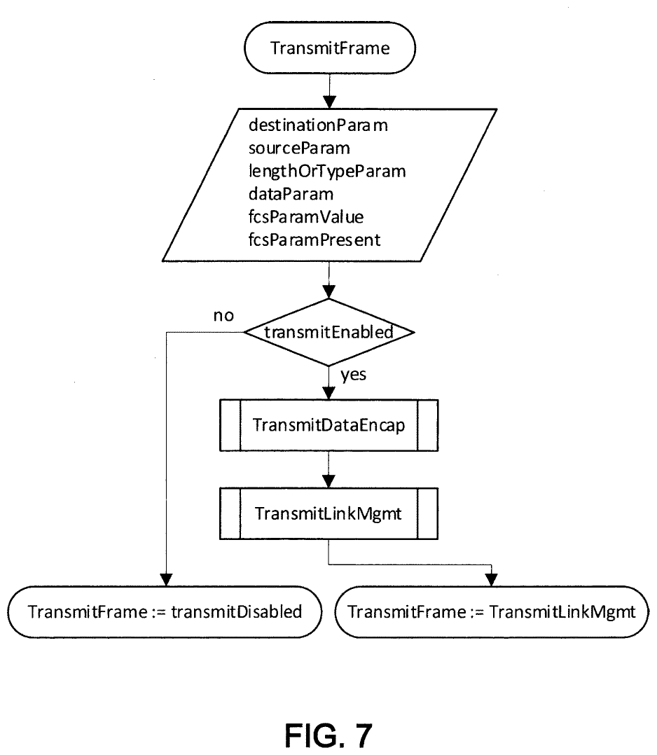

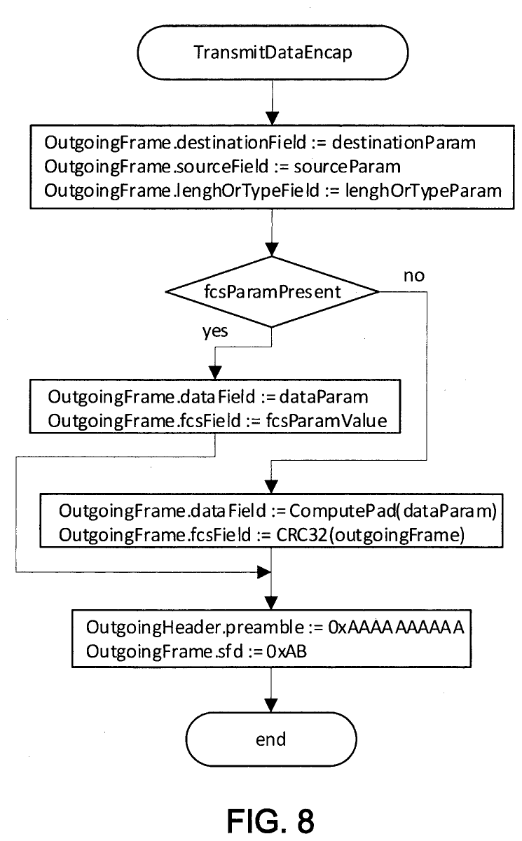

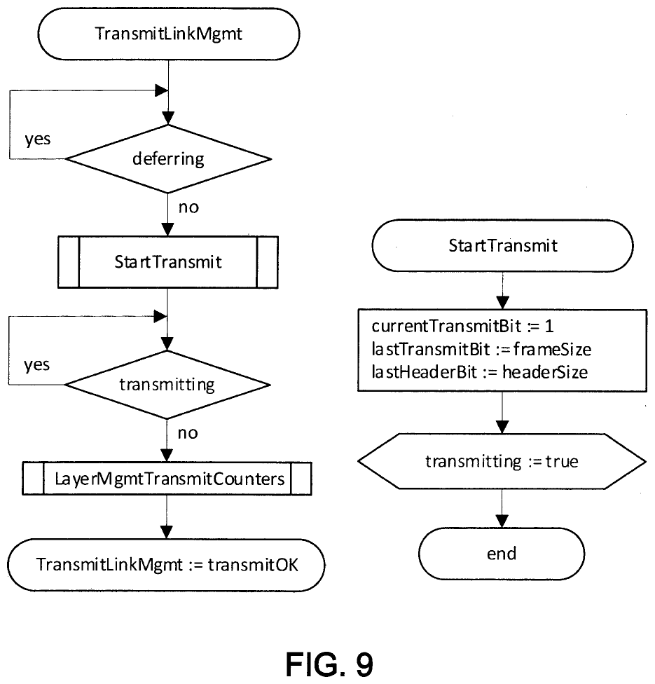

If transmission is enabled, the TransmitFrame operation of FIG. 7 first calls a TransmitDataEncap procedure presented in FIG. 8 to assemble the frame from the parameters passed by the MAC client and then calls the TransmitLinkMgmt procedure of FIG. 9 to initiate the actual frame transmission.

The MAC client indicates if it passes the frame check sequence for the frame through the fcsParamPresent. If it does, it also passes the fcsParamValue parameter and provides for the necessary padding. If the fcsParamPresent parameter is false, the fcsParamValue parameter is unspecified and the TransmitDataEncap first calls the ComputePad function, followed by a call to the CRC32 function (for 32-bit cyclic redundancy check) to generate the padding (if necessary) and the frame check sequence field for the frame.

It is to observe that the lengthOrTypeParam is a remain of legacy Ethernet MAC specifications. It is described later in the present disclosure how it is treated when generating the request primitive between the MAC client and sublayer.

As shown in FIG. 9, procedure TransmitLinkMgmt is in charge of transmitting the frame. When deferenceMode is true, it first defers to the Physical Layer if it is not ready for the next packet and to ensure proper interframe spacing.

LayerMgmtTransmitCounters updates transmit and transmit error counters.

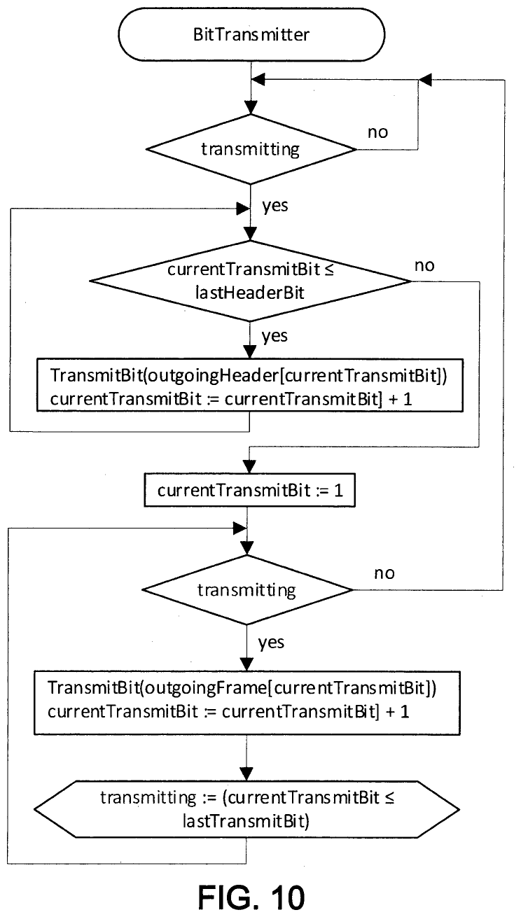

Each time a frame transmission is initiated, StartTransmit is called to signal the BitTransmitter process that bit-by-bit transmission can start. The transmitting variable is used to synchronise the TransmitLinkMgmt (reacting to events issued by the MAC client) and the BitTransmitter process that is synchronous of the physical link timing, as shown in FIG. 10.

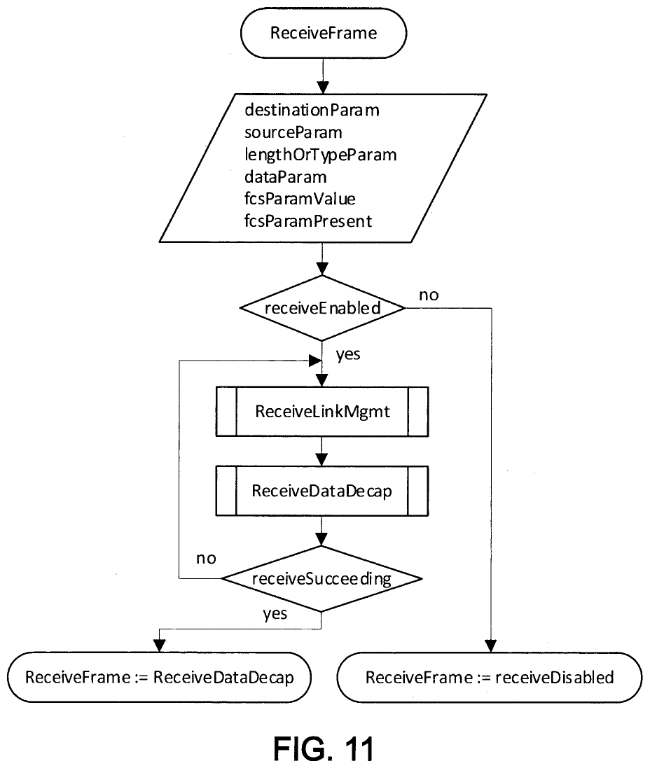

As for the IEEE 802.3 MAC Sublayer Frame Reception, the ReceiveFrame operation is synchronous of the actual frame reception: it lasts for the entire frame reception duration and completes when it is fully received, as shown in FIG. 11. The fields of the frame are delivered through the output parameters with the ReceiveStatus status code.

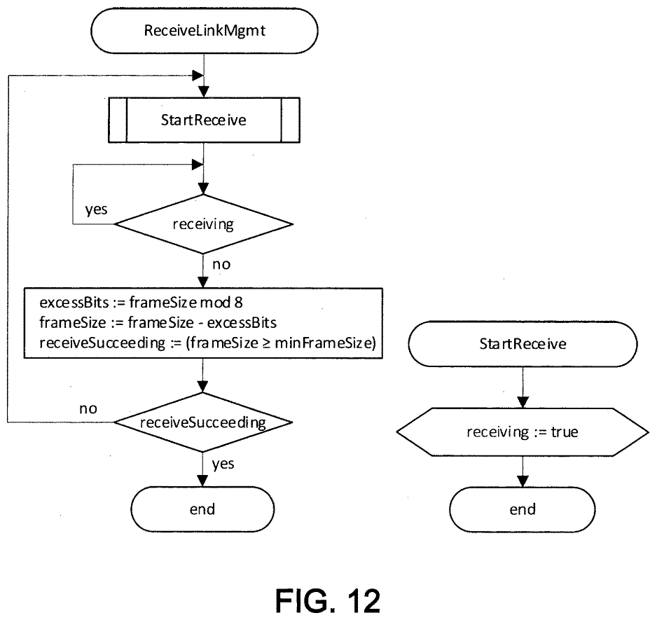

If enabled, ReceiveFrame calls ReceiveLinkMgmt to receive the next valid frame, and then calls the internal function ReceiveDataDecap to return the frame's fields to the MAC client depending on the frame's DA (see ReceiveDataDecap's description). The returned ReceiveStatus indicates possible errors in the frame, as shown in FIG. 12.

The procedure ReceiveLinkMgmt continuously initiates then the reception of frame bits, discarding any fragments smaller than the minimum valid frame size.

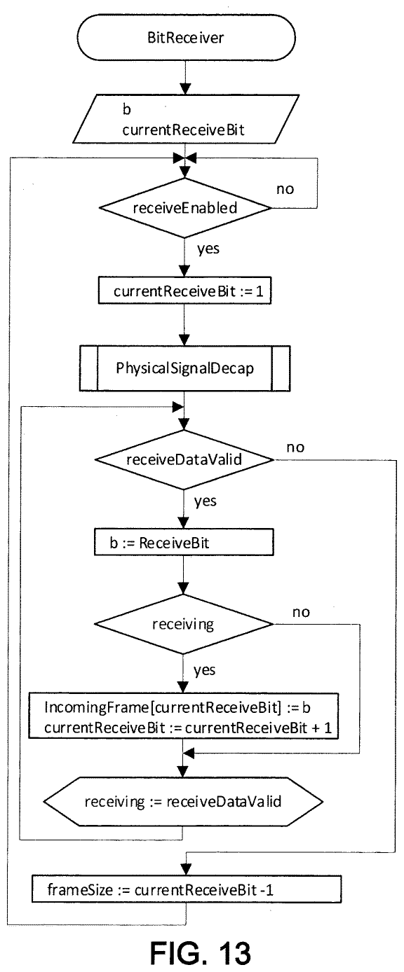

As shown in FIG. 13, the BitReceiver process is synchronised on the Physical Layer bit timing determined by the ReceiveBit operation, partitioning them into frames.

The receiving variable is used to couple the asynchronous ReceiveLinkMgmt and BitReceiver processes.

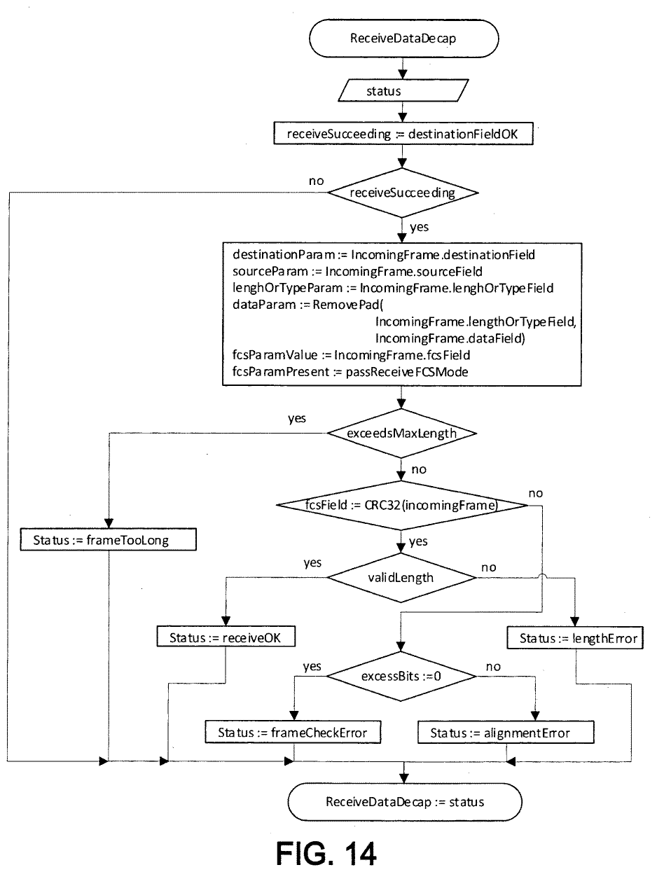

PhysicalSignalDecap checks from successive bits from the Physical Layer if a valid Start Frame Delimiter (SFD) is detected, in which case it is discarded as presented in FIG. 14.

The function ReceiveDataDecap is called by ReceiveFrame to return the frame's fields to the MAC client if the frame's address has an expected value.

The returned ReceiveStatus indicates the presence or absence of detected transmission errors in the frame.

The destinationFieldOK function checks if the destination address field of the incoming frame contains the address of the receiving station. When the Ethernet interface of the station is in “promiscuous” mode, any destination address is considered as valid. The same condition applies for bridges' ingress ports, resulting in destinationFieldOK being always TRUE.

It is to observe that the lengthOrTypeParam is a remain of legacy Ethernet MAC specifications. It is described below how it is treated when generating the indication primitive between the MAC sublayer and client.

For the sake of simplifying the description, the processing (removing) of a potential padding is not shown.

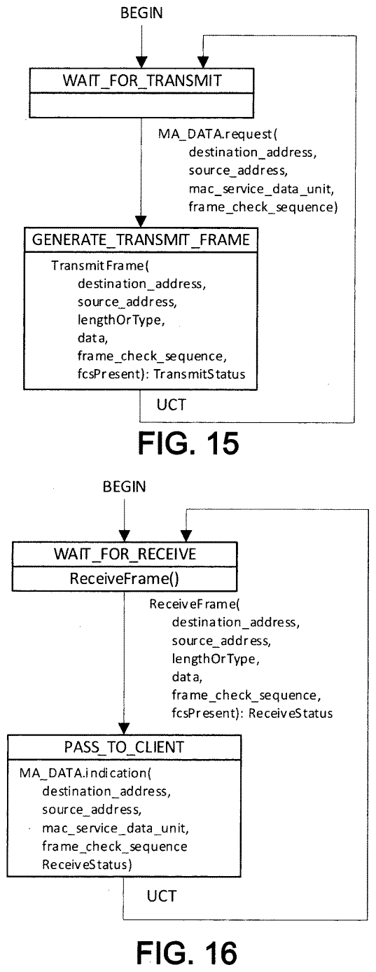

As for now the IEEE 802.3 MAC Service implementation, the MAC sublayer provides services of MAC frames transmission and reception to the MAC client through the service primitives MA_DATA.request and MA_DATA.indication. The following state machines (presented in FIGS. 15 and 16 commented below) define the relationship between the TransmitFrame and ReceiveFrame functions, and these service primitives.

FIG. 15 shows the MAC client transmit interface operation, where the mac_service_data_unit parameter passed through the MAC client MA_DATA.request primitive is the concatenation of the lengthOrType field and the data field passed to the MAC sublayer.

It can be noted that the TransmitStatus can be ignored here when operating in full duplex mode.

FIG. 16 shows the MAC client receive interface operation, where the lengthOrType field and the data payload field parsed from the received MAC frame are concatenated to form the mac_service_data_unit parameter passed with MA_DATA.indication primitive.

It can be noted that the ReceiveStatus included in the primitive's parameters can be ignored here by the MAC client in bridges, i.e. the ISS.

The following description specifies the modifications made to the IEEE 802.3 MAC sublayer to support cut-through forwarding. For this purpose, the frames are handled segment by segment, called “chunks” hereafter.

In transmission, the MAC client provides a series of chunks to the TransmitFrame function and guarantees that the resulting series of bits passed to the Physical Layer is uninterrupted as long as the frame to be transmitted is not completely transferred over the MAC service interface.

In reception, chunks are progressively passed up to the MAC client each time a number of bits equal to the chunk size is extracted from the Physical Layer.

The position of a chunk in the array of bits constituting a frame can be signaled by its offset relative to the beginning of the frame.

The interface of the TransmitFrame operation is modified in order to accommodate for chunk parameters.

The organization of the TransmitFrame operation is otherwise not modified:
it first calls the TransmitDataEncap procedure to assemble the frame from the parameters passed by the MAC client, and then
calls the TransmitLinkManagement procedure to trigger the actual frame transmission.

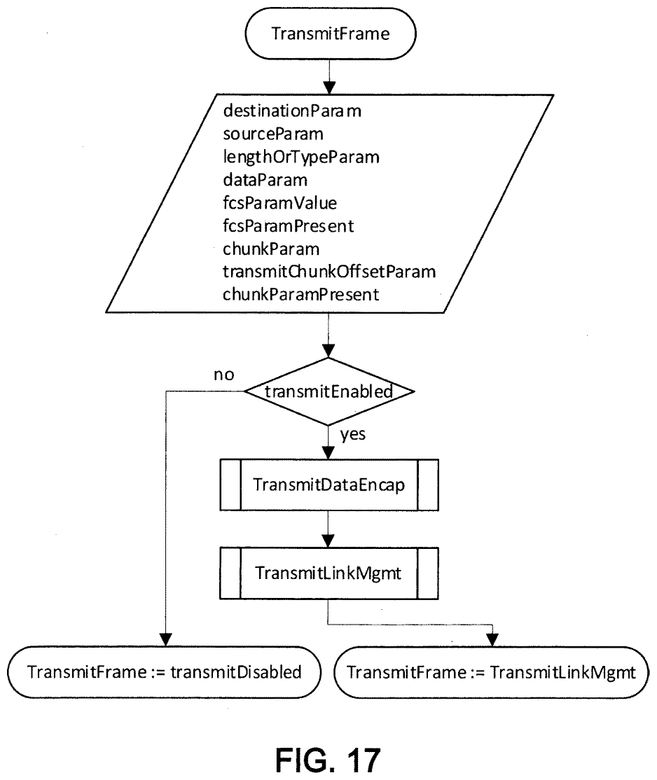

As shown in FIG. 17, the parameter “chunkParam” is the chunk parameter of size chunkSize. chunkSize is preferably a number of octets.

transmitChunkOffsetParam is the offset of the chunk contained in the parameter chunkParam. It is preferably expressed as a number of octets relative to the beginning of the frame.

chunkParamPresent indicates if a chunk is passed as parameter of TransmitFrame. If TRUE, TransmitFrame takes as input parameters: chunkParam and transmitChunkOffsetParam, all other frame parameters being ignored. If FALSE, the set of parameters defined in IEEE Std 802.3 are taken as input, ignoring chunkParam and transmitChunkOffsetParam.

In cut-through mode, it is the responsibility of the MAC client to correctly insert the different fields of a frame in the successive chunks it passes to the CTF MAC sublayer: i.e. the destination and source addresses, MAC service data unit and FCS (see TransmitDataEncap description below). It is also the MAC client responsibility to guarantee that the frame length is greater than the minimum authorized frame size and that is aligned on an octet boundary.

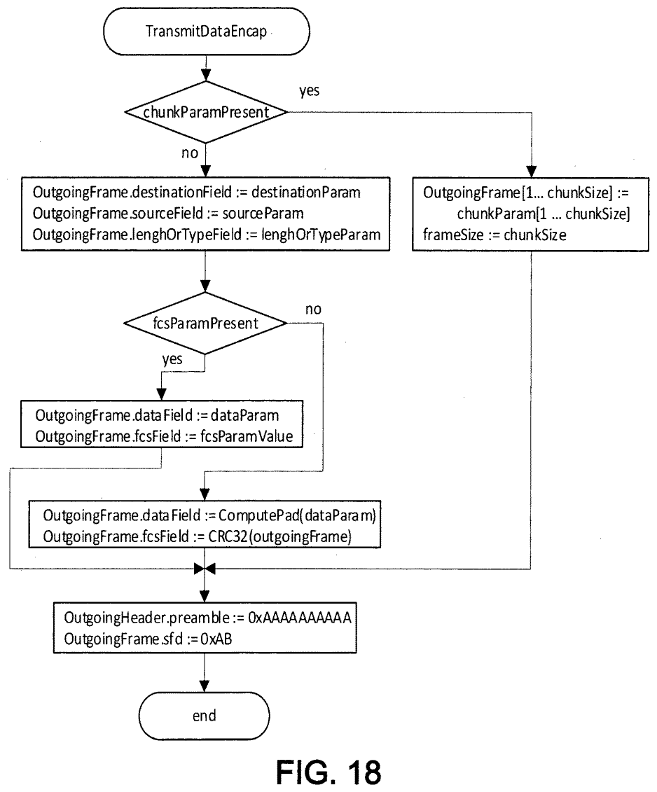

As presented in the example of FIG. 18, the TransmitDataEncap procedure is modified to check if a chunk is to be processed instead of a whole frame. If chunkParamPresent is TRUE, the only action taken by this process is to prepend a preamble and an SFD at the head of the chunk. In case of cut-through operation, TransmitDataEncap does not process the legacy frame parameters (addresses, mac service data unit, FCS).

In cut-through mode, TransmitDataEncap is called only once for the transmission of the first chunk of the frame, for example.

The TransmitLinkMgmt, StartTransmit and BitTransmitter procedure remain unchanged compared to the one specified in IEEE Std 802.3.

As for the CTF MAC Transmission Service, a new primitive can be invoked by the MAC client and is defined below as a MA_DATA_CHUNK.request which takes as parameters:
Chunk: the segment of frame to be transmitted
transmitChunkOffset: the offset of the chunk relative to the beginning of the frame.

The MA_DATA.request primitive remains unchanged and is invoked when operating in store-and-forward mode.

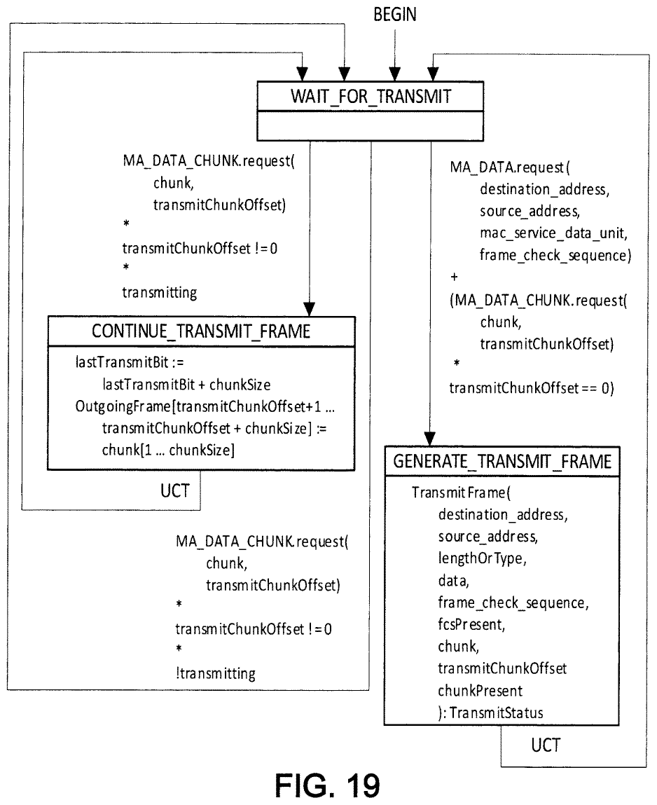

The state machine shown in FIG. 19 specifies the operation of the MAC service interface that supports both cut-through and store-and-forward modes.

A new state is introduced, CONTINUE_TRANSMIT_FRAME that updates the variable handled by the asynchronous BitTransmitter procedure (lastTransmitBit, OutgoingFrame[ ]).

lastTransmitBit is a usual parameter indicating a frame end in the store and forward mode and here in the cut-through mode it corresponds to the last bit of the last received chunk (the last transmitted bit of the last received chunk).

If the lastTransmitBit has not been updated before the Physical Layer receives a new Chunk, then the physical layer stops encoding but can interpret that the received frame is finally ended.

The modified TransmitFrame procedure is called when the MAC client invokes the MA_DATA.request primitive (store-and-forward mode) or when the MAC client invokes the MA_DATA_Chunk.request primitive with the initial chunk of a frame (transmitChunkOffset parameter equals 0).

When in cut-through mode, the MAC client continues the transmission of the successive chunks of a frame, following the initial chunk, by further invoking the MA_DATA_Chunk.request, thus updating the lastTransmitBit variable when the state machine enters the CONTINUE_TRANSMIT_FRAME state, causing the BitTransmitter process to continue providing bits for transmission by the Physical Layer.

If the MAC client is late in providing a non-initial chunk, i.e. the BitTransmitter process has finished transmitting the bits of the previous chunk and has set the transmitting variable to 0, the MA_DATA_Chunk.request primitive invocation is ignored as well as further ones until the MA_DATA_Chunk.request primitive is invoked for the transmission of an initial frame chunk.

In that case, a truncated, possibly too short, frame is transmitted (with the lastTransmitBit indication process explained above to end up a frame processing when necessary).

As for the CTF MAC Sublayer Frame Reception, the ReceiveFrame operation is left unchanged: if enabled, it first calls the ReceiveLinkMgmt procedure followed by the ReceiveDataDecap procedure.

The ReceiveLinkMgmt and the StartReceive procedures, also left unchanged, initiate the frame bit transfer between the Physical Layer and the MAC sublayer as long as the Physical Layer detects bits belonging to a physical frame.

The ReceiveDataDecap procedure is not modified either, performing the same frame checks and field decapsulation operations.

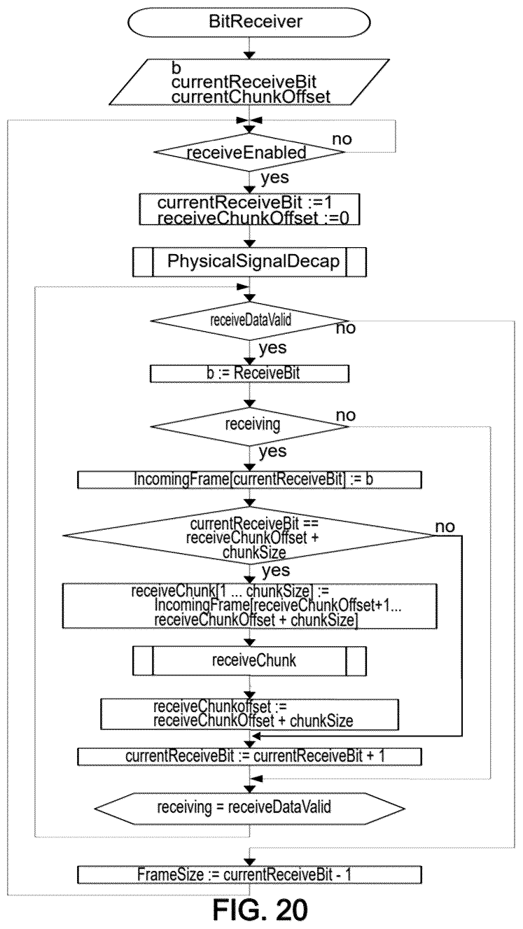

The BitReceiver procedure is modified so that it delineates the chunks from the train of bits received from the Physical Layer, as shown in FIG. 20.

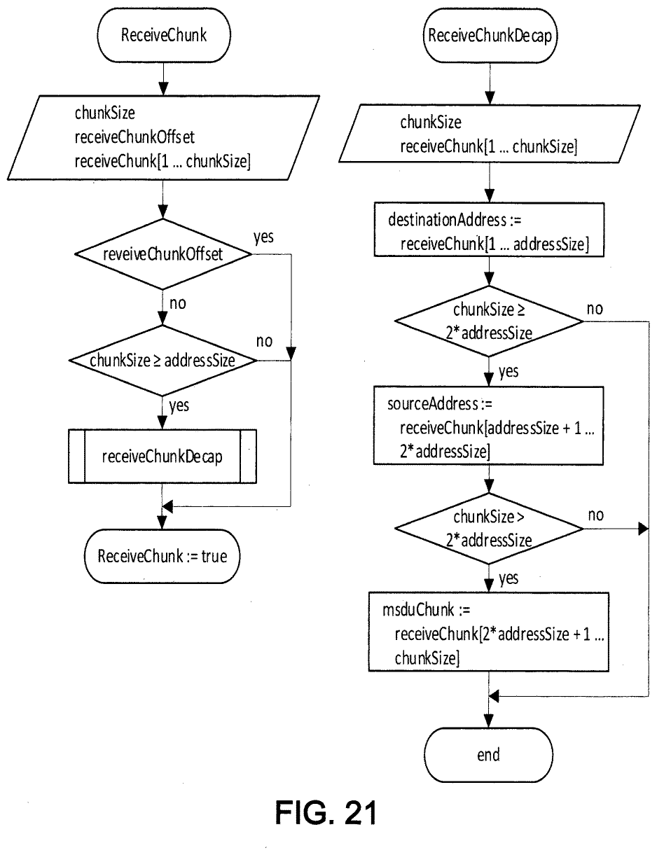

As long as the receiveDataValid is set to TRUE by the Physical Layer, the successive bits decoded by the Physical Layer are accumulated to form the received frame (IncomingFrame[ ]). When a number of bits equivalent to receiveChunkSize is received, the availability of a chunk (a segment of IncomingFrame[ ]) is detected (receiveChunk) and the ReceiveChunk procedure is called with the parameters of the chunk: the offset of the chunk (receiveChunkOffset) and the bit array constituting the chunk (receiveChunk[ ]), as shown in FIG. 21.

The parameter receiveChunkSize is fixed and set through a configuration procedure not described in this specification. Its value is preferably a number of octets.

The ReceiveChunk procedure first checks if the chunk is the initial chunk of a frame (receiveChunkOffset equals 0). In case of an initial chunk which length is larger than the size of an Ethernet address, the receiveChunkDecap procedure is called, that attempts to delineate the destination address, the source address and the MAC service data unit or part thereof.

The ReceiveChunk procedure also returns a signal set to TRUE upon its completion. This signal is used by the CTF MAC Reception Service state machine to generate the chunk availability indication primitive towards the MAC client.

The state machine of the CTF MAC Reception Service handles the indication of the reception of a whole frame the same way for both cut-through and store-and-forward modes of operation. The last chunk of a frame received in cut-through mode is signaled by the emission of the usual primitive MA_DATA.indication.

To accommodate the cut-through mode of operation, the CTF MAC Reception service interface relies on a modified state machine and provides an additional primitive: MA_DATA_CHUNK.indication.

MA_DATA_CHUNK.indication provides the following set of parameters to the MAC client:
receiveChunk:
receiveChunkOffset: the position of the received chunk in the frame, relative to the beginning of the frame
destination_address: the destination address carried by the frame if the received chunk is the first of a frame and its length is larger than that of an address
source_address: the source address carried by the frame if the received chunk is the first of a frame and its length is more than, or, twice as large as that of an address
msdu_chunk: the mac service data unit, or part thereof, carried by the frame if the received chunk is the first of a frame and its length is more than twice as large as that of an address.

A store-and-forward MAC client is compatible with the new service interface by simply ignoring the MA_DATA_CHUNK.indication primitives.

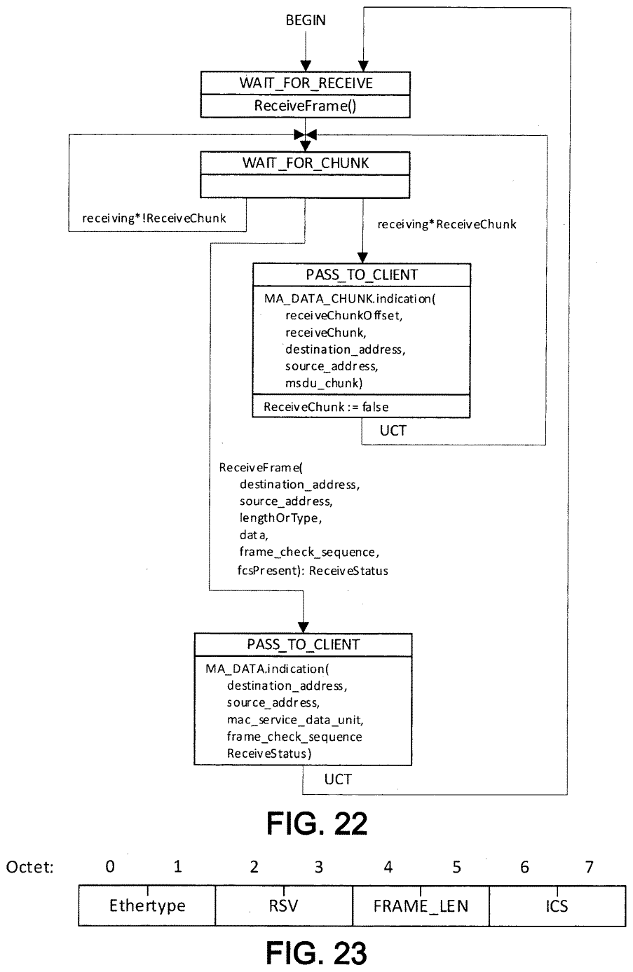

As shown in FIG. 22, after the WAIT_FOR_RECEIVE state launches the ReceiveFrame operation, chunk reception is signalled to the MAC client each time a frame fragment of receiveChunkSize is received and as long as the receiving signal is activated by the ReceiveLinkMgmt procedure and maintained by the BitReceiver procedure.

Once the frame is completely received, i.e. the receiving signal is deactivated, the standard IEEE 802.3 MA_DATA.indication is passed to the MAC client and the reception of the next frame (and chunks) is awaited.

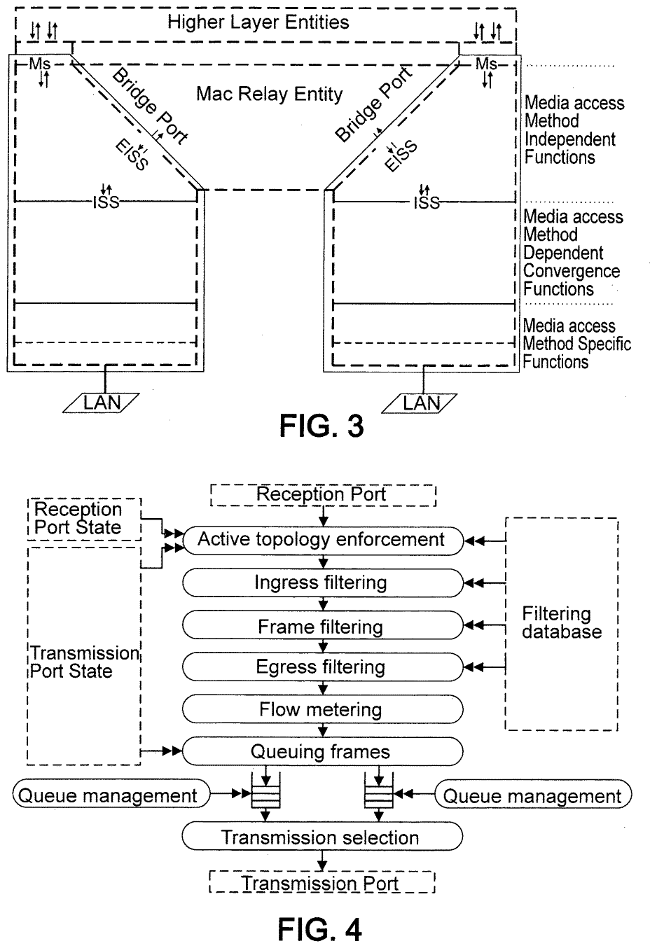

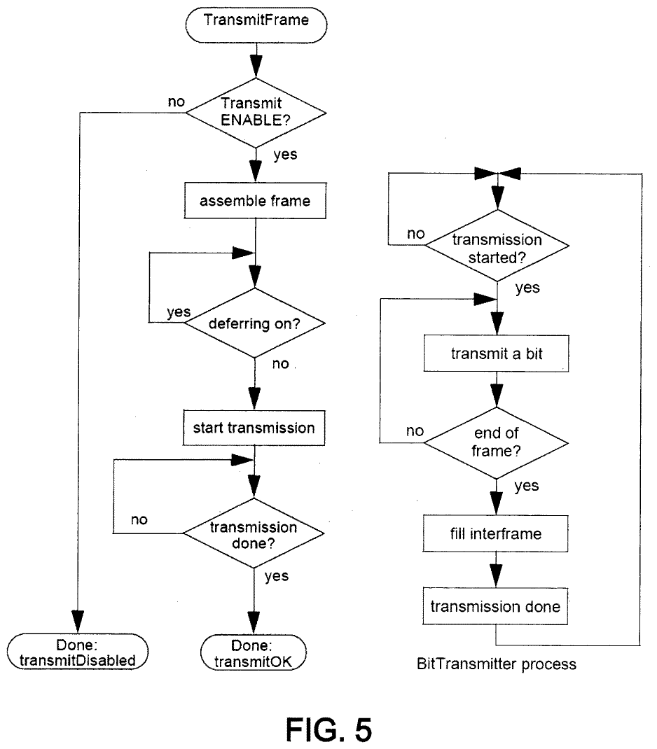

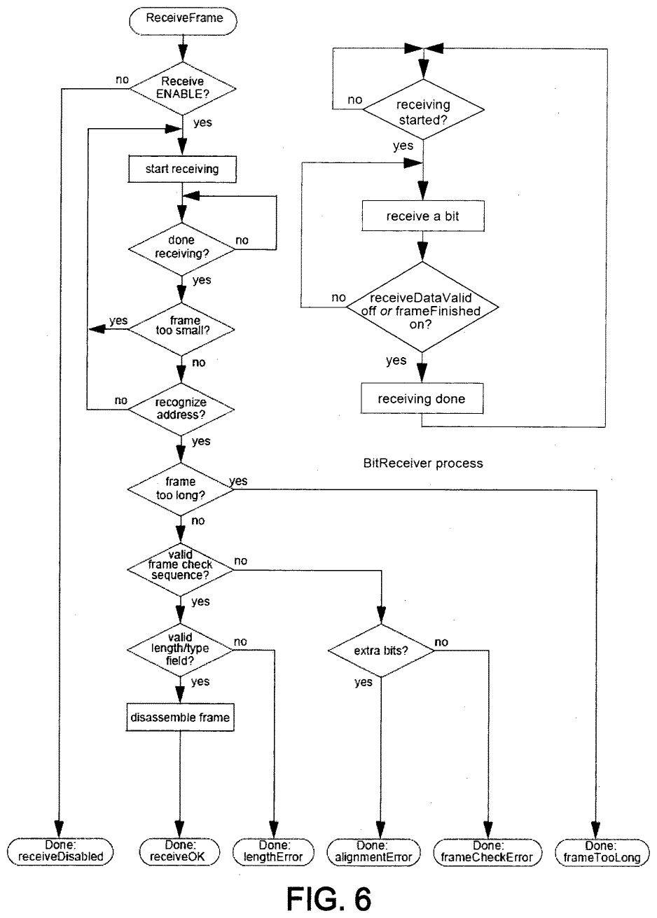

Referring back to FIG. 3 again, the forwarding process included in the bridge's relay entity performs various operations on the received frames that depends on some of their data fields content and on their length.

The cut-through MAC client must also be able to determine if a received frame is to be cut-through or store-and-forwarded. For this purpose, it requires some classification information preferably present in the first frame chunk received (when the minimum latency must be achieved).

The relaying and classification information may consist in the destination and source addresses as well as additional information included in the MAC service data unit. This is for instance the case when a forwarding decision or classification is based on the combination of the destination address, VLAN-ID and PCP values. The VLAN-ID and PCP (Priority Code Point) are included in the VLAN-Tag (as specified in IEEE Std 802.1Q) that is, in most application configurations, contained in the first two octets of the mac service data unit.

In order to avoid wrong forwarding or classification decisions, an error detection code can be inserted in the frame at a position located right after the information required for these decisions. This error detection code is called Intermediate Check Sequence hereafter.

In addition, the frame length information can be explicitly signalled in another information field, also protected by the Intermediate Check Sequence.

A tag, called hereafter the “CTF-Tag”, is defined as carrying the fields listed below and shown in FIG. 23:
The Ethertype defining the Tag type (CTF-Tag): 2 bytes,
A reserved field (RSV): 2-bytes,
The frame length (FRAME_LEN): 2 bytes,
The Intermediate Check Sequence (ICS): 2 bytes.

The CTF-Tag value is unique and possibly assigned by an IEEE Registration Authority.

The RSV field is an information place holder reserved for a further use not necessarily related to cut-through forwarding.

FRAME_LEN is a value in octets, that accumulates the lengths of the destination address, source address, mac service data unit and FCS.

The ICS is preferably a 16-bit Cyclic Redundancy Check code computed over the destination address, source address and mac service data unit part up to the CTF-Tag, including the CTF-Tag.

The CTF-Tag is inserted by the CTF MAC client prior to the transmission of the frame at an offset that is specified by the management entity of the CTF MAC client. The information of this position is used by a peer CTF MAC client (in reception) to locate the CTF-Tag and perform the ICS computation on the corresponding part of the received frame.

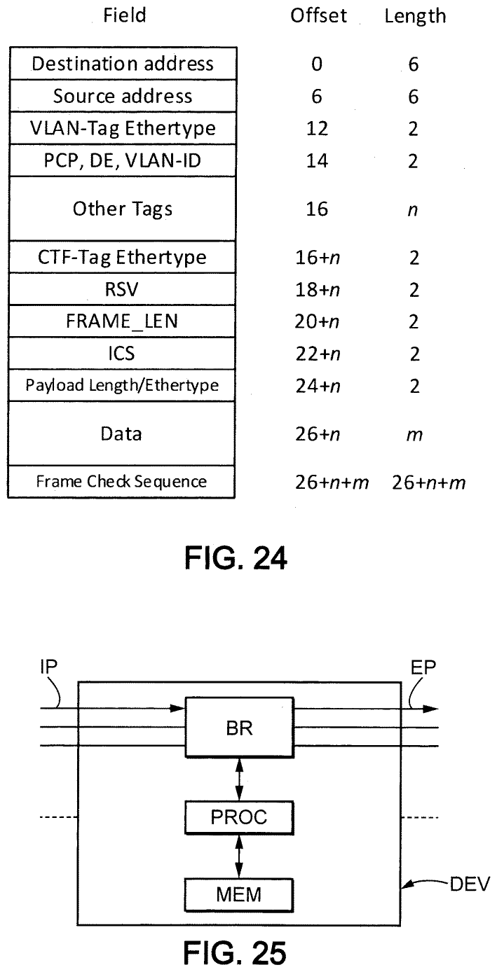

FIG. 24 illustrates the format of a frame including a CTF-Tag.

The receive CTF MAC client discards the frame when the computed ICS value does not match the received ICS value.

When in cut-through mode of operation, the MAC client may then update a counter that counts the frame received with an errored ICS in addition to a counter of errored frames.

FIG. 25 shows an example of a communication device DEV including a bridge BR comprising ingress ports IP and egress ports EP, linked to a processing circuit including a processor PROC and a memory MEM. The memory MEM stores at least instructions data of a computer program according to the present disclosure and the processor PROC can access to the memory MEM to read the instructions data and implement the method presented above (in transmission through an egress port or in reception through an ingress port).

1. A method for transmitting an Ethernet MAC frame, implemented by a communication device having an egress port to form the frame to be transmitted based on received data of said frame, said communication device comprising a bridge comprising at least said egress port and operating according to an OSI layers' model comprising:
a MAC sublayer for providing a MAC service,
an upper layer related to a MAC client,
and a lower physical layer,
The method comprising:
Checking whether, among said data of the frame, at least one parameter (chunk, transmitChunkOffset, chunkPresent) related to a segmentation of said frame is present, and
When said parameter is present, said MAC client provides a series of frame segments called “chunks” to the MAC sublayer to implement a frame transmit function (TransmitFrame), uninterruptedly as long as the frame to be transmitted is not completely transferred over the MAC service layer,
the forming of the frame being started at the egress port without waiting for a reception of all the frame data, according to a cut-through forwarding mode.

2. (canceled)

3. The method of claim 1, wherein said frame data further include a chunk size parameter and chunks are progressively passed up to the MAC client each time a number of bits of the frame equal to the chunk size parameter is received from said physical layer.

4. The method according to claim 1, wherein said frame data further include a chunk offset parameter indicating a position of a chunk in a succession of bits constituting the frame, relatively to a beginning of the frame.

5. The method according to claim 1, wherein a specific primitive is invoked by said MAC client (MA_DATA_CHUNK.request) for requesting a transmission service to said MAC sublayer and defines parameters related to:
A chunk, aiming at a segment of frame to be transmitted, and
A chunk offset (transmitChunkOffset), aiming at an offset of said chunk relative to a beginning of the frame.

6. The method according to claim 5, wherein the frame transmit function (TransmitFrame) calls a procedure (TransmitDataEncap) for encapsulating frame data to transmit, said procedure including a checking as to whether a chunk is to be processed instead of a whole frame, depending on whether said parameter (chunkParamPresent) is present or not, respectively.

7. The method of claim 6, wherein said procedure, when said parameter is present, prepends a preamble and a start frame delimiter at a head of a first chunk of the frame.

8. The method of claim 7, wherein said first chunk is identified by a “0” chunk offset, indicating thereby a start of a new frame.

9. The method according to claim 1, wherein, when receiving from another communication device a frame formed according to said cut-through forwarding mode, the MAC sublayer launches a bit receiving procedure (BitReceiver) comprising a delineation of successive chunks which are passed to the MAC client, from a train of bits received from said physical layer.

10. The method of claim 9, wherein, as long as a last chunk of said frame received in said cut-through forwarding mode is not received by the MAC sublayer, a specific primitive (MA_DATA_CHUNK.indication) indicates the successive chunks passed to the MAC client.

11. The method of claim 10, wherein, when said last chunk is received by said MAC sublayer, a general primitive (MA_DATA.indication) is launched to indicate an end of reception of the whole frame.

12. The method according to claim 10, wherein a first chunk of the received frame is identified by a “0” chunk offset, indicating thereby a start of the received frame, and wherein said specific primitive (MA_DATA_CHUNK.indication) declares furthermore at least a destination address, a minimum size of a chunk being at least equal to a field bitlength of said destination address, said MAC sublayer launching a procedure (receiveChunkDecap) to decapsulate chunks of the received frame, to delineate at least said destination address.

13. The method according to claim 1, wherein a tag is added to the frame data before the frame transmission, said tag:
indicating that the frame was formed according to the cut-through forwarding mode, and
comprising at least one data (FRAME_LEN; ICS) for a frame checking at a frame reception, and wherein said communication device, at a reception of a frame from another communication device according to the cut-through forwarding mode:
determines whether said tag is present in the frame, and
in that case, reads said data in the tag to check whether the frame is erroneous or not.

14. The method according to claim 1, wherein said parameter related to said frame segmentation is declared among other parameters including at least a destination and/or source addresses, and wherein said communication device, in said cut-through forwarding mode, ignores said addresses to start directly forming the frame at the egress port.

15. The method according to claim 14, wherein a communication device being not configured to implement said cut-through forwarding mode, ignores said parameter related to the frame segmentation and starts processing the frame data by taking into account said other parameters including at least said addresses.

16. A computer program comprising instructions causing the implementation of the method according to claim 1, when such instructions are run by a processor.

17. A communication device, comprising a processing circuit to implement the method according to claim 1.
